(19) United States
(12) Patent Application Publication
(10) Pub. No.: US 2010/0023430 A1
(43) Pub. Date: Jan. 28, 2010

(54) SYSTEM AND METHOD FOR COORDINATING THE PRODUCTION AND PROCESSING OF SEED SUPPLIES, AND THE PREPARATION AND UTILIZATION OF SEED SAMPLES

(75) Inventors: James L. Hunter, Littleton, CO (US); Timothy P. Meyer, Des Moines, IA (US)

Correspondence Address: ALSTON & BIRD LLP;PIONEER HI-BRED INTERNATIONAL, INC., BANK OF AMERICA PLAZA, 101 SOUTH TRYON STREET, SUITE 4000, CHARLOTTE, NC, 28280-4000, US

(73) Assignee: Pioneer Hi-Bred International, Inc.

(21) Appl. No.: 12/492,868

(22) Filed: Jun. 26, 2009

Related U.S. Application Data
(60) Provisional application No. 61/083,348, filed on Jul. 24, 2008.

(51) Int. Cl. G06Q 10/00

(52) U.S. Cl. 705/28

(57) ABSTRACT

A system and method for coordinating the production, processing, and utilization of seed is provided. In various embodiments, the method and system aggregate seed inventory data, identify seed requests, and query the seed requests against the seed supply information. If the query results in a match a seed source can be automatically identified. Further, identified seed can be automatically allocated to the identified seed request from the identified seed source.

### CROSS REFERENCE TO RELATED APPLICATIONS

The present application claims priority from U.S. Provisional Application No. 61/083,348, filed Jul. 24, 2008, which is hereby incorporated herein in its entirety by reference.

### FIELD OF THE INVENTION

The various embodiments of the present invention relate generally to seed supply management systems. More specifically, embodiments of the present invention provide a system and method for coordinating the production and processing of seed supplies, and the preparation and utilization of seed samples.

### BACKGROUND OF THE INVENTION

Plant breeding, plant product development, plant product characterization, and plant product commercialization often require the creation of a large number of seed samples from the available supply of seed from a specific source, genotype, population, and/or breeding line. For example, in agricultural research, it is often necessary to segregate a seed sample from a bulk seed sample such that the seed sample includes one or more selected seeds (representing a statistically-significant population, for example). Such seed samples may have a desired genotype or the seed of the seed sample may have other characteristics, such as being treated with a selected treatment compound (e.g., a particular fungicide or insecticide).

In order to generate and manage seed having desired genotypes or other characteristics, seed may undergo several transformational steps. In general, the steps may include production, processing, preparation, and utilization. In particular, they may include harvesting a crop, processing the crop to create bulk samples, preparing seed samples from the bulk seed samples, planting, growing and/or storing seed samples. In conventional systems, these steps are accomplished primarily through manual means and are typically carried out in isolation. Accordingly, any documentation relating to these steps is maintained manually and without reference to other related steps. These uncoordinated, manual steps result in seed supply chains that lack visibility, and demand for seed that cannot be considered heuristically. As a result, requests for seed are evaluated in isolation, often resulting in the unnecessary delay in obtaining desired seed and unnecessary manufacture of redundant seed supplies. As such, the manual procedures involved in the steps of seed manufacture are inherently inefficient, especially with regard to tracking, planning, and coordinating, the production, processing, preparation, and utilization of seed.

Accordingly, there is a need in the art for a system and method of coordinating the production, processing, preparation, and utilization of seed. The system and method should heuristically consider the various steps in the manufacture of seed. Such a heuristic approach should be accomplished in a variety of ways such that desired seed can be located and retrieved from various locations and identified in and/or retrieved from various steps associated with seed production, processing, preparation, and utilization.

### SUMMARY OF VARIOUS EMBODIMENTS

The embodiments of the present invention satisfy the needs listed above and others. Embodiments of the present invention may include a method for coordinating production, processing, preparation, and utilization of seed. In addition, the present invention also provides various embodiments directed to a system for coordinating the production, processing, preparation, and utilization of seed.

In one embodiment, the present invention provides a method that comprises identifying at least one seed request, the seed request containing at least one desired characteristic, automatically identifying at least one available seed source having seed with the desired characteristic, and automatically allocating via a processor the at least one identified seed source to the at least one seed request. In some embodiments, the processor is a processor of an application server. In some embodiments, the at least one seed request may be derived from one or more seed utilization plans that may be stored in a data store. In some embodiments, seed may be allocated according to one or more preferences contained in the seed utilization plans.

In some embodiments, the at least one available seed source may be identified from at least one of current management systems or current seed inventory. In some embodiments, current management systems may comprise seeds to be produced, seeds to be processed, seeds to be prepared, seeds to be utilized, and/or combinations thereof. In some embodiments, at least a portion of the seeds to be produced may comprise seeds to be processed by a seed processing system. In some embodiments, at least a portion of the seeds to be utilized may comprise seeds to be produced by a seed production system. In some embodiments, at least a portion of the seeds to be processed may comprise seeds to be prepared by a seed sample preparation system. In some embodiments, at least a portion of the seeds to be prepared may comprise seeds to be utilized by a seed utilization system.

In some embodiments, the current seed inventory may comprise at least a portion of seeds processed by seed processing system, seeds prepared by a seed sample preparation system, seeds from other seed sources, and/or combinations thereof. In some embodiments, the seeds to be processed by the seed processing system may be identified in a data store that communicates with the seed processing system. In some embodiments, the seeds to be produced by the seed production system may be identified in a data store that communicates with the seed production system. In some embodiments, the seeds to be prepared by the seed sample preparation system may be identified in a data store that communicates with the seed sample preparation system. In some embodiments, the seeds to be planted by the seed utilization system are identified in a data store that communicates with the seed utilization system. In some embodiments, at least a portion of the seeds of the current seed inventory are identified in a data store that communicates with the current seed inventory. In some embodiments, the desired characteristics, such as genotypes are identified using seed inventory identifiers.

In another embodiment, the steps of identifying at least one seed request containing at least one desired characteristic, automatically identifying at least one available seed source having the desired characteristic, and automatically allocating the at least one identified seed source to the at least one seed request occur via an application server. In some embodiments, the application server communicates with at least one data store, wherein at least one of the application server and the data store communicates with the current management systems, and wherein at least one of the application server and the data store communicates with the current seed inventory. In some embodiments, automatically identifying at least one available seed source having the desired characteristic comprises querying the current seed inventory before querying the current management systems. In some embodiments, automatically identifying at least one available seed source having the desired characteristic comprises querying a seed inventory system before querying a seed processing system. In some embodiments, automatically identifying at least one available seed source having the desired characteristic further comprises querying a seed processing system before querying a seed preparation system. In some embodiments, automatically identifying at least one available seed source having the desired characteristic further comprises querying a seed preparation system before querying a seed production system.

In another embodiment, the present invention provides a system comprising a seed production system configured to produce at least a portion of seeds, a seed processing system configured to process at least a portion of seeds from the seed production system, a seed sample preparation system configured to prepare a least a portion of seeds from the seed processing system, a seed utilization system configured to plant a least a portion of seeds from the seed sample preparation system, a seed inventory configured to store seeds from at least one of seeds processed by the seed processing system, seeds prepared by the seed sample preparation system, and seeds from other seed sources, and a data store in communication with the seed production system, the seed processing system, the seed sample preparation system, and the seed utilization system, wherein the data store comprises at least one experiment plan, wherein at least one seed request containing at least one desired characteristic is derived from the at least one experiment plan, wherein the coordinating system is configured to automatically identify at least one available seed source from among seed produced from the seed production system, seeds processed by the seed processing system, seeds prepared by the seed sample preparation system, seeds utilized by the seed utilization system, and seeds stored by the seed inventory, and wherein the coordinating system is further configured to automatically allocate the at least one identified seed source to the at least one seed request.

Some embodiments further comprise an application server in communication with the data store, wherein the application server is configured to automatically identify at least one available seed source and automatically allocate the at least one identified seed source to the at least one seed request. In some embodiments, the seed processing system may be configured to process at least a portion of seeds from the seed production system. In some embodiments, at least one seed request is derived from one or more experiment plans stored in one or more data stores. Some embodiments may further comprise a secondary data store configured to communicate with the seed processing system and the data store, and wherein the coordinating system automatically identifies at least one available seed source and allocates the at least one identified seed source to the at least one seed request through communication between the data store and secondary data store. Some embodiments may further comprise a secondary data store configured to communicate with the seed sample preparation system and the data store, and wherein the coordinating system automatically identifies at least one available seed source and allocates the at least one identified seed source to the at least one seed request through communication between the data store and secondary data store.

### BRIEF DESCRIPTION OF THE DRAWINGS

Having thus described the invention in general terms, reference will now be made to the accompanying drawings, which are not necessarily drawn to scale, and wherein:

FIG. 1 is a schematic representation of a seed material flow between various management systems and inventory systems in accordance with various exemplary embodiments of the present invention;

FIG. 2 shows a schematic representation of an exemplary seed coordinating system that may operate in cooperation with the seed material flow shown in FIG. 1, in accordance with various exemplary embodiments of the present invention;

FIG. 3 shows a schematic representation of another exemplary seed coordinating system that may operate in cooperation with the seed material flow shown in FIG. 1, in accordance with various exemplary embodiments of the present invention; and

FIG. 4 shows a flowchart of an exemplary method of fulfilling seed requests according to various exemplary embodiments of the present invention.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Although the embodiments of the present invention may be useful by themselves, they are also useful in conjunction with the systems, methods, and computer program products disclosed in U.S. patent application Ser. No. 11/774,230, which claims priority to U.S. Provisional Patent Application No. 60/806,684, and U.S. Pat. No. 6,706,989, which are assigned to the assignee of the present application and are incorporated herein by reference in their entirety.

Various embodiments of the present invention assemble information regarding available seed supply in order to facilitate the location of seed that can be used to fulfill seed requests. In an exemplary embodiment where the requested seed is to be used in experiments, seed requests may be derived from experiment plans. Embodiments of the present invention may be utilized with respect to a seed supply of any type of seed including, but not limited to, corn seed, soybean seed, alfalfa seed, canola seed, sorghum seed, sunflower seed, wheat seed, or the like. Exemplary embodiments of the present invention may define the seed supply as including not only seed located in inventory systems, such as seed inventories and other sources, but also seed being acted upon by various management systems. These management systems may include seed production systems, seed processing systems, seed sample preparation systems, and seed utilization systems.

In this regard, the demand for seed can be determined from seed requests. Seed requests can be generated by entities desiring seed of a particular type. In some exemplary embodiments, seed requests may be generated by the coordinating system based on a demand for seed gathered from, for example, experiment plans. In this regard, in some exemplary embodiments, the seed requests may be aggregations of a plurality of demands for seed, but may be considered as a single seed request. As such, seed requests may include requirements for seed having particular characteristics needed for various other uses (e.g., crop production). In embodiments where the seed requests are derived from experiment plans, the experiment plans may include requirements for seed having particular characteristics needed to perform various experiments. Seed requests may be any type of request, order, or set of requirements or preferences for a quantity of seed. Seed requests may include instructions regarding the characteristics of desired seed (e.g., genotype), where the seed should be shipped, where and how the seed should be planted, and/or the like.

Exemplary embodiments of the present invention may include a processor that automatically identifies seed sources and automatically allocates at least one identified seed source to at least one seed request. In various embodiments, the processor may be embodied in a number of different ways. For example, the processor may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In some embodiments, the processor may be configured to execute instructions stored in a memory device or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. In some embodiments, the processor may be a processor of a specific device (e.g. an application server) adapted for employing embodiments of the present invention by further configuration of the processor by instructions for performing the algorithms and/or operations described herein. In some embodiments, the processor may include, among other things, a clock and logic gates configured to support operation of the processor.

In the depicted embodiments the processor is a processor of an application server or other entity that may query one or more data stores, to locate seed which meets the requirements of the seed requests. In some embodiments, a primary data store can assemble data from various systems to facilitate locating desired seed anywhere in the management and storage seed. If a desired seed type is located, an order for the seed can be directed to the appropriate management or inventory system and the seed can be designated to the appropriate seed request.

Accordingly, seed requests can include requirements, which must be satisfied, and preferences, which may be satisfied, if possible. Preferences may be user-defined, or the processor or other entity, may analyze the seed request and determine whether characteristics that were called for in the request may be considered as preferences, rather than requirements. In this regard, the utilization of preferences (which allow for a broader range of acceptable seed) rather than requirements (which allow for a narrower range of acceptable seed) can increase the likelihood of locating seed that matches the request, since a larger pool of potential matches can be utilized.

For example, a seed request may set a requirement for seeds of a particular genotype. The exemplary seed request may also set a user-defined preference that all seeds be retrieved from storage in a particular storage location, (e.g. Location A). A query determines that only a certain number of seeds less than the number required of that genotype are available for use in a seed inventory at Location A, but additional seeds are available for use in a seed inventory at some other location, (e.g., Location B). The result can be a match, and orders for the seed can be transferred to the appropriate locations as indicated in the instruction of an associated seed request. In some embodiments, where a requirement or preference cannot be satisfied, an alternative seed type which is available for use can be recommended and a user can chose whether to accept the alternative.

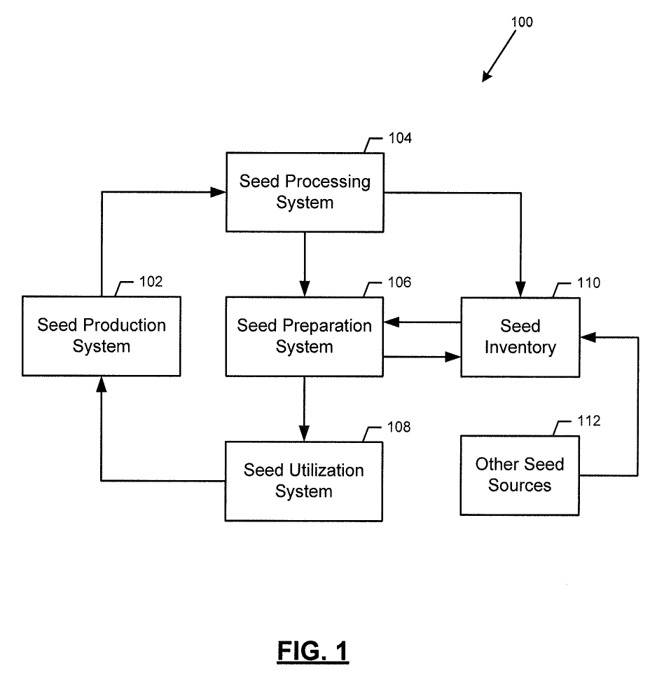

FIG. 1 illustrates a schematic representation of a seed material flow 100 between various management and inventory systems in accordance with one exemplary embodiment of the present invention. As discussed in further detail below, the seed material flow 100 of the depicted embodiment generally includes various management systems such as a seed production system 102, a seed processing system 104, a seed sample preparation system 106, and a seed utilization system 108. Seed material flow 100 can also include inventory systems such as seed inventory 110, and other seed sources 112.

While the following description of the management and inventory systems of seed material flow 100 can treat the systems and entities as single, defined units, various embodiments of the present invention contemplate that these systems and entities can be widely dispersed and activities of the systems and entities may overlap. For example, seed inventory 110 can be physically located at one or more physical locations and data stored in association with seed inventory 110 can be located on one or more storage devices located at one or more physical locations. Further, various activities may be associated with the management and inventory systems described herein. It is contemplated that the associations of activities (e.g., harvesting, sorting, sampling, storing, planting, etc.) to management and inventory systems are merely exemplary and various associations of activities to management and inventory systems may be utilized in exemplary embodiments of the present invention. It also contemplated that some of the activities associated with management and inventory systems may be substituted with other similar activities, or excluded.

The various activities described with respect to the exemplary management and inventory systems described herein, can be monitored, controlled, and coordinated via various control systems. A control system can include a computing system that can be used to facilitate monitoring (e.g., data acquiring and tracking), controlling (e.g., automating), and coordinating (e.g., sharing information) in order to facilitate the manufacture and storage of seed. In some embodiments, control systems may be Supervisory Control and Data Acquisition (SCADA) or peer-to-peer systems. Each control system can employ a data storage device, such as a data server or a secondary data store, to log and track information about the seeds. In some embodiments, each management or inventory system may employ a one or more separate control systems. However, various data stores associated with the control systems may include communications connections to other control systems, secondary data stores and/or the primary data store. For example, in some embodiments, various control systems associated with seed processing systems can also utilize a common data storage device, such as a seed sample tracking system. Additionally, or alternatively, in some embodiments, the various control systems associated with seed processing systems can utilize a storage system that is distributed across a plurality of data storage devices.

In various embodiments, the seed production system 102 may comprise apparatuses and/or methods configured for producing seed from one or more plants. The seed production system 102 may comprise apparatuses that may include data processing apparatuses, such as, but not limited to, computing devices implementing databases, data stores, processing devices, computer terminals, and the like, and seed production apparatuses, such as, but not limited to, apparatuses for growing, harvesting, and removal of the seed from the production environment, and/or separation of the seed from the main plant structure that supports the seed (e.g., the stem or the stalk). Methods that may comprise seed production system 102 can include, but not limited to, methods for or related to receiving and storing data relating to producing seed, and methods relating to growing, harvesting, and removal of the seed from the production environment, and/or separation of the seed from the main plant structure that supports the seed (e.g., the stem or the stalk).

Seed production system 102 may receive seed from plants that were planted by seed utilization system 108 (described in further detail below) in a seed production environment to produce additional seed used to ultimately generate a bulk seed sample. In various embodiments, a seed production environment may include, but need not be limited to, one or more seed plots, a field, a greenhouse, a hoop house, a growth chamber, a lab, any combination of the above, etc. For example, if the seed is corn seed, ears of corn may be harvested from a particular production environment. In this regard, seed production system 102 may include various control systems that monitor, control, and coordinate the growth plants and the harvesting of seed. The control systems may include a harvest data entry system for inputting data about seeds that have been harvested.

Upon harvesting the seed, a unique source identifier can be assigned to the harvested seed. In this regard, the unique source identifier may be assigned for each harvested seed or seed sample. The source may refer to where (i.e., the particular production environment) the seed was harvested or the source may refer to a generic source. In some embodiments, the unique source identifier can be a seed inventory identifier. The seed inventory identifier can be used to track the seed as the seed moves through the seed material flow 100. Information about seed can be stored in relation to the seed inventory identifier to provide for retrieval of the information when queries are performed to locate seed having various characteristics. In some embodiments, the seed inventory identifier can include codes or information that may be appended to or otherwise associated with the seed inventory identifier as the seed moves through seed material flow 100 such as, for example, date of production (which may be added by seed production system 102), storage location (which may be added by seed inventory 110), and seed treatment (which may be added by seed sample preparation system 106).

In various embodiments, the seed processing system 104 may comprise apparatuses and/or methods configured for processing harvested seed. The seed processing system 104 may comprise apparatuses that may include data processing apparatuses, such as, but not limited to, computing devices implementing databases, data stores, processing devices, computer terminals, and the like, and seed processing apparatuses, such as, but not limited to, apparatuses for drying, shelling or threshing, cleaning, sizing, sorting, weighing, counting, or otherwise quantifying seed to generate a bulk seed sample. Methods that may comprise seed processing system 104 can include, but not limited to, methods for or related to receiving and storing data relating to processed seed, and methods relating to drying, shelling or threshing, cleaning, sizing, sorting, weighing, counting, or otherwise quantifying seed to generate a bulk seed sample.

For example, in various embodiments plant seed may be processed by drying the seed, which may be monitored moisture using measuring equipment associated with a control system. The seed may further be shelled and/or threshed and directed to a cleaner. The cleaner can separate desirable seed from undesirable seed based on size and/or shape. A sorter or other apparatus may also sort the seed based on various criteria such as color or weight in order to further process the seed. After sorting, in some embodiments, the seed can be counted. After sorting the resulting seed can be packaged into bags, or various other containers and the containers can be labeled. In some embodiments, the container may be marked with a seed inventory identifier associated with the seed. After the seed is processed to generate a bulk seed sample by seed processing system 104, the bulk seed sample can be delivered to a seed inventory 110 or the seed can be delivered to seed sample preparation system 106.

Various control systems may be associated with the seed processing system 104. For example, control systems may be included that monitor bulk samples of corn ears as they are processed, monitor unshelled and dried ear samples as they are processed, or the like. The control systems of processing system 104 may store information in a secondary data store with regard to the processed seed, and store data that may be associated with the seed inventory identifier associated with the processed seed. Further, the control systems can interact with the secondary data store to collect information that may have been stored by seed production system 102 about the seed being processed or seed that has been processed. Additionally, at various steps within the processing of the seed, information about the seed, such as characteristics including genotype, expected storage location, date of production, and seed count, can be stored in a secondary data store associated with the seed processing system 104 and the various control systems that may be included within seed processing system 104.

In this regard, it should be noted that portions of seed processing system 104 can be utilized for more than one type of plant and, as such various apparatuses, such as the secondary data store, can be shared amongst processing procedures associated with different plants. For more information regarding seed processing systems and control systems associated with seed processing system see U.S. Pat. No. 6,706,989, entitled “Automated High-Throughput Seed Sample Handling System and Method” and U.S. Pat. No. 7,290,665, entitled “Automated High-Throughput Seed Sample Handling System and Method,” both of which are hereby incorporated by reference herein in their entirety.

Seed inventory 110 can receive bulk seed samples from seed processing system 104 for storage, or receive seed samples (i.e., samples taken from a bulk seed sample) from seed sample preparation system 106 for storage. In this regard, seed inventory 110 can be logically and physically defined. Seed that is designated to seed inventory 110 can be physically located in any number of seed storage locations. Seed in seed inventory 110 may be transported to a designated location such as a holding facility or other physical storage area. Additionally, seed can be designated to the seed inventory from a logical perspective. As such, seed inventory may include an associated data store and/or control system. In this regard, seed may be physically located in any physical location, but a logical designation can be associated with the seed in various computing systems and associated data stores indicating that the seeds are flagged as inventory seeds. As such, in some exemplary embodiments of the present invention, seed may simply be logically designated as inventory seed, but no change in the physical location of the seed may occur. Further, in this regard, seed that is commercially available or otherwise available, such as from other seed sources 112, may be included in seed inventory, and as such can be a source of seed for seed inventory 110.

Seed material flow 100 can also include a seed sample preparation system 106. Seed sample preparation system 106 can receive processed seed from seed processing system 104 or seed inventory 110, and further prepare the seed for planting. In various embodiments, the seed sample preparation system 106 may comprise apparatuses and/or methods configured for preparing seed for planting. The seed sample preparation system 106 may comprise apparatuses that may include data processing apparatuses, such as, but not limited to, computing devices implementing databases, data stores, processing devices, computer terminals, and the like, and seed sample preparation apparatuses, such as, but not limited to, apparatuses for receiving processed seed, generating seed samples (also know as aliquots) from a bulk seed sample, quantifying seed samples, weighing seed samples, treating seed samples (i.e., applying of fungicides, herbicides, and/or insecticides), packaging seed samples, labeling packaged seed samples, delivering seed samples, tracking the delivery of seed samples, and providing instructions as to how prepared seed samples should be planted. Methods that may comprise seed sample preparation system 106 can include methods for receiving processed seed, generating seed samples (also know as aliquots) from a bulk seed sample, quantifying seed samples, weighing seed samples, treating seed samples (i.e., applying of fungicides and/or insecticides), packaging seed samples, labeling packaged seed samples, delivering seed samples, tracking the delivery of seed samples, and providing instructions as to how prepared seed samples should be planted.

In various embodiments of the present invention, seed sample preparation system 106 can prepare seed received from seed processing system 104 or processed seed retrieved from seed inventory 110. Upon receipt of the seed from either seed processing system 104 or seed inventory 110, the processed seed can be prepared by generating a seed sample of a bulk seed sample, based on for example, a characteristic such as a genotype, or a group of characteristics. According to various embodiments, a seed sample can be any amount of seed of a particular type. In some embodiments, prior to generating a seed sample, the seed may be retrieved from seed inventory 110. The seed can be further prepared by removing the selected seed from processing containers. After the seed sample has been identified, any remaining seed, i.e. seed that is not part of the seed sample, can be delivered to seed inventory 110. The seed sample can be placed in a second packaging container that is used in the planting process. The second packaging container can be labeled and the labeling can include unique identifiers, such as a seed inventory identifier, bar codes, other information that can be used to determine the characteristics of the seed within the container, and/or instructions regarding the planting of the seed within the container. In some embodiments, the seed packaging can be marked with a seed inventory identifier which can be used to retrieve data from various storage devices regarding the seed within the packaging. The seed inventory identifier can be used to retrieve various characteristics about the seed such as, but not limited to, genotype, storage location, date of production, existing seed treatment, seed count, seed weight, seed color, the location of the seed production environment where the seed was grown, or the like. Upon placement into the second packaging container the seed sample can be prepared for delivery to a particular location for planting or other analysis.

Seed sample preparation system 106 can also include various control systems. For example, seed sample preparation system 106 can include a control system for creating seed samples and preparing the seed sample for planting or other analyses. Control systems associated with seed sample preparation system 106 can also include a computing system and a secondary data store which can be used to facilitate monitoring, controlling, and coordinating the preparation of seed, and to store information about the prepared seed. As such, throughout the process of preparing seed samples, seed sample preparation system 106 and the control systems associated with seed sample preparation system 106 can store information about the prepared seed samples, such as characteristics including genotype, storage location, date of production, exiting seed treatment, and seed count. The information can be stored in a secondary data store associated with the seed sample preparation system 106.

After preparing the seed, the seed can be received by seed utilization system 108 for planting. Seed utilization system 108 can receive prepared seed from seed sample preparation system 106 and plant the prepared seed. In various embodiments, the seed utilization system 108 may comprise apparatuses and/or methods configured for planting seed. The seed utilization system 108 may comprise apparatuses that may include data processing apparatuses, such as, but not limited to, computing devices implementing databases, data stores, processing devices, computer terminals, and the like, and seed planting apparatuses, such as apparatuses for determining planting instructions, planting seed samples, and providing information to various computing systems regarding planted seed samples. Methods that may comprise seed utilization system 108 can include methods for determining planting instructions, planting seed samples, and providing information to various computing systems regarding planted seed samples.

In various embodiments of the present invention, seed utilization system 108 can plant prepared seed samples received from seed sample preparation system 106. In some embodiments, the prepared seed can be planted according to instructions that have been imprinted on the container of the prepared seed samples or instructions retrieved from a secondary data store. After planting the seed samples, according to some embodiments, information regarding the physical, planted placement of the seed, such as geographic location or arrangement of the seed within a production environment can be stored in the secondary data store.

Seed utilization system 108 can also include various control systems. For example, seed utilization system 108 can include an advanced planter control system for storing information regarding the physical, planted placement of the seed. Control systems associated with seed utilization system 108, such as the advanced planter control system, can also include a computing system and a secondary data store which can be used to facilitate the storing of information regarding planting seed.

The seed planted in accordance with seed utilization system 108 can be planted in one or more seed production environments. In some embodiments, a production environment may have particular characteristics, such as climate and soil characteristics. In some instances, the characteristics of the production environment can be based on the geographic location of the production environment. In other embodiments, the characteristics of the production environment may be prescribed. Through the control systems associated with the seed utilization system 108, the characteristics of seed in various production environments can be retrieved from the secondary data store associated with seed utilization system 108. In this regard, the seed content of various seed production environments can be determined using the data stored in the secondary data store associated with seed utilization system 108.

When the seeds planted in seed production environments mature into plants that are ready for harvesting, seed production system 102 can harvest seed from the mature plants as discussed above with respect to seed production system 102. In this regard, the procedure of managing and storing seed can begin anew with respect to the recently harvested seed.

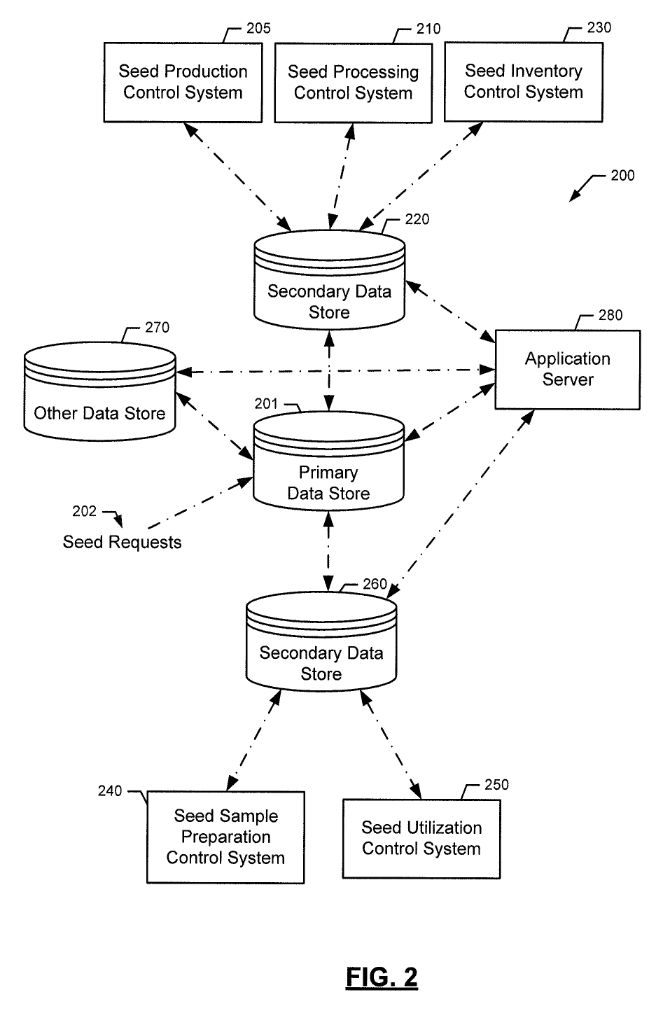

Having described the seed material flow 100, FIG. 2 depicts a schematic representation of an exemplary seed coordinating system 200 according to various embodiments of the present invention including computing and storage devices associated with the management and inventory systems, and their respective control systems, of seed material flow 100. The computing and storage devices of FIG. 2 can be connected via communication links between systems in accordance with one embodiment of the present invention. The communication links generally indicate how data from various entities can be transferred, shared, aggregated or be otherwise made available to seed coordinating system 200 and various entities connected to the seed coordinating system 200.

In this regard, the depicted embodiment includes an application server 280, which may be a server that includes a processor and software and/or hardware that allows application server 280 to receive communications or communicate with various other components of the seed coordinating system 200. In some embodiments, application server 280 may be a plurality of computing devices in a distributed network of computing devices with communications links between the computing devices and the network. The communication links can be network connections between the various computing and storage elements and the network. In this regard, the network configuration can be, but is not limited to, a local area network (LAN), a wide area network (WAN), the Internet or some combination of networking technologies. Although in the depicted embodiment, application server 280 is shown having communication links with primary data store 201, secondary data stores 220, 260, and other data store 270, in other embodiments, application server 280 may communicate with one or more of the seed production control system 205, seed processing control system 210, seed inventory control system 230, seed sample preparation control system 240, and seed utilization control system 250. It should be noted that other embodiments of the present invention need not include an application server, in such embodiments the functions of the application server may be embodied in one or more other components of the seed coordinating system 200.

Primary data store 201 can be any type of computing device that includes a storage device. For example, primary data store 201 may be a computer, a server, or the like. Since data relating to seeds can be found in storage devices associated with the various management and inventory systems described with respect to the seed material flow 100 of FIG. 1, application server 280 can utilize the communication links between the various computing and storage devices to determine if and where desired seed is located within the seed coordinating system 200. It should be noted that although in the depicted embodiment the application server 280 determines if and where the seed is located within the seed coordinating system 200, in other embodiments other entities of the seed coordinating system 200 may make this determination. Such entities may include, but need not be limited to, the primary data store 201, secondary data stores 220, 260, other data store 270, or any combinations thereof.

Application server 280 can determine a demand for seed types based on seed requests 202 via a communication link with primary data store 201. Seed requests 202 can include descriptions of seed requirements and may include shipping, planting, or other instructions. In FIG. 2, seed requests 202 are depicted as being an input to the primary data store 201 for illustration purposes as representing one exemplary embodiment. However, according to various exemplary embodiments of the present invention, seed requests 202 may be input into the coordinating system 200 from any one or any combination of network entities. A seed request 202 may require a type of seed having particular characteristics such as genotype, storage location, date of production, exiting seed treatment, seed count, seed weight, seed color, the location of the seed production environment where the seed was grown, etc. In some instances, seed requests 202 may require a type of seed where only a subset of the various characteristics associated with seeds is required for the seed request 202. For instance, a particular seed request 202 that is derived from an experiment plan may require a seed of a particular genotype for experimentation, but other characteristics associated with the seed, such size, treatment or storage location may be irrelevant to the experiment. As such, various seed types, i.e., seed having differing characteristics, may satisfy the requirements of a particular seed request 202, which can increase the potential for locating seed that matches the requirements of a seed request 202 within management and inventory systems of seed material flow 100.

Application server 280 can also determine a supply of various seed types via communications links to secondary data stores associated with the control systems of the management and inventory systems of seed material flow 100. With regard to determining supply, application server 280 may convert the values for weights of seed stored in various secondary data stores into seed counts to be utilized in filling seed requests 202.

According to various embodiments, the supply of seed, determined from communication links to various secondary data stores, such as data stores 220 and 260, and the demand for seed derived from seed requests 202 can be considered heuristically so as to maximize the number of matches available amongst the various seed requests 202. In heuristically considering the demand for seed and the supply of seed, application server 280 may consider the requirements and preferences of the various seed requests 202 to maximize matching between the seed requests 202 and the supply.

As such, in conformity with a heuristic approach, application server 280 may identify a seed request 202 and perform a query which targets seed having a particular type based on the seed request 202. If the results of the query and the heuristic analysis of the seed supply indicate that seed matching the seed type needed for a seed request 202 is available for use in the management or inventory systems of seed material flow 100, an order for the seed can be generated. The system where the requested seed currently resides can receive the order and actions can be taken to make the seed available for the seed request 202. The actions taken can vary based on the location of the seed within the seed material flow 100 and the instructions for shipping or planting provided in the seed request 202. In the event that no match for the requested seed is found, an order can be generated to grow the seed or an alternative seed can be recommended.

Referring to FIG. 2, when application server 280 performs a query, the communication links of seed coordinating system 200 can be utilized. In this regard, in some exemplary embodiments of the invention, data stored in association with the management or inventory systems of seed material flow 100 can be aggregated from localized data stores into primary data store 201 and the query can be a local query of the aggregated data stored within primary data store 201. In various other embodiments, data stored in association with the management or inventory systems of seed material flow 100 can be made available for remote querying by application server 280 of localized data stores via communications links to the localized data stores.

With respect to performing a query to identify matches for seed requests 202, application server 280 may, in some embodiments, determine a status of a seed type requested. A status can indicate whether a particular seed type is no longer available for use due to the seed type being banned by government regulation or the status may indicate that the seed type requires a certification to cross political borders. Further, a status may indicate that a particular seed type is barred from use by contractual or legal considerations, or otherwise unavailable due to various obstacles which prevent utilization of the seed type.

Application server 280 can proceed to perform a query to determine if the requested seed type is available within the seed material flow 100 as indicated by data gathered from the entities of seed coordinating system 200. Application server 280 can query data that can be retrieved via communications links to primary data store 201, secondary data stores 220, 260, and other system data store 270. Secondary data store 220 can retain data stored by seed production system 205, seed processing system 210, and seed inventory 230, which may be associated with seed production system 102, seed processing system 104, and seed inventory 110, respectively. In this regard, secondary data store 220 may include storage devices associated with the various control systems of seed production system 102, seed processing system 104, and a data store or control system associated with seed inventory 110. Similarly, secondary data store 260 can retain data stored by seed sample preparation system 240 and seed utilization system 250, which may be associated with seed sample preparation system 106, and seed utilization system 108, respectively. In this regard, secondary data store 260 may include storage devices associated with the various control systems of seed sample preparation system 106, and seed utilization system 108. Other data store 270 can retain genetic marker data generated for making individuals or lines in a breeding program. According to various embodiments, secondary data stores 220, 260 and other data store 270 can be compilations of numerous data storage devices located at various physical locations and the communications links between secondary data stores 220, 260, and other data store 270, and primary data store 201, which may also be a distributed network of data stores, can be representative of numerous communication links between the numerous storage devices and the primary data store 201.

Further, in some exemplary embodiments, a preferential order of seed sources may be considered when querying the data stored to locate seed that matches a seed request. In this regard, the availability of seed from the various sources may be considered in a preferred order. For example, in some embodiments, seed inventory may be the most available seed source, and as such queries for seed may be first directed to seed inventory data. In some exemplary embodiments, seed in seed processing may be queried next to find a match, since the seed has yet to be packaged, and re-labeling would be unnecessary if seed is located in the seed processing system. The query may next consider seed in the seed preparation system. Although, seed in the seed preparation system may have already been packaged, re-labeling or other solutions may allow seed located in the seed preparation system to be matched and associated with a seed request. Seed utilization and seed production may be the least available seed source, and as such, seed data from these management systems may be last data to query since, in some instances, seed in these sources may not be mature enough for harvest and conversion to useable seed.

Secondary data store 220 can contain data regarding the seed available for use in the seed production system 205, seed processing system 210, or seed available for use in the seed inventory 230. Accordingly, the data associated with secondary data store 220 can be queried. In some embodiments of the present invention, application server 280 can query data associated with the seed inventory 230 via a direct communications link to seed inventory 230. If upon querying the data associated with the secondary data store 220, a match to a seed request is identified, an order can be sent to the management or inventory system where the seed is located, for example seed production system 205, seed processing system 210, or seed inventory 230.

Secondary data store 260 can contain data regarding the seed available for use in the seed sample preparation system 240 or seed available for use in seed utilization system 250. Accordingly, the data associated with secondary data store 260 can also be queried. If upon querying the data associated with the secondary data store 220, a match to a seed request is identified, an order can be sent to the system where the seed is located, for example seed sample preparation system 240 or seed utilization system 250.

Other data store 270 can contain data regarding the seed available for use in genetic markers data. Seed available for use in this regard can be seed currently growing on plants located in various production environments. Accordingly, the data associated with other data store 270 can also be queried. If upon querying the data associated with other data store 270, a match to a seed request is identified, an order can be sent with instructions as to what actions should be taken.

Orders can be automatically generated and can allocate the identified seed to the appropriate request. An order can also provide instructions to take action with respect to the requested seed, such as ship the seed to a particular location for analysis, or direct that the seed be planted according to instructions provided in a seed request. In some embodiments, a notification such as an email can be sent to the appropriate system to provide instructions with respect to the requested seed. Further, the order can include seed production, processing, preparing, and/or utilizing information which can be provided to the secondary data stores 220, 260. The seed production, processing, preparing, and/or utilizing information can then be utilized by the appropriate management or inventory systems to obtain the requested seed. In situations where the seed is located on plants, such as in seed production system 102, the order can be automatically sent to data store 260 and seed production system 205 to ensure that the seeds are harvested by seed production system 102, and later processed, prepared, and/or utilized in accordance with the instructions provided in the seed request.

According to various embodiments of the present invention, metrics can be developed with respect to determining supply and demand for seed types based on comparisons between seed requests 202 and the fulfillment of seed requests 202. These metrics may provide an indication that manufacture of a particular seed type is not supplying adequate volumes/numbers of seed or that seed processing is removing too much seed during conversion of raw bulk samples into clean useable seed samples. As such, based on the generated metrics, supplies of particular seed types may be increased due to an expected increase in use or demand of the particular seed type. In this regard, for example, increases in supply may be implemented by seed coordinating system 200 via application server 280 by generating orders for seed types and providing instructions that the seed be placed in seed inventory after processing.

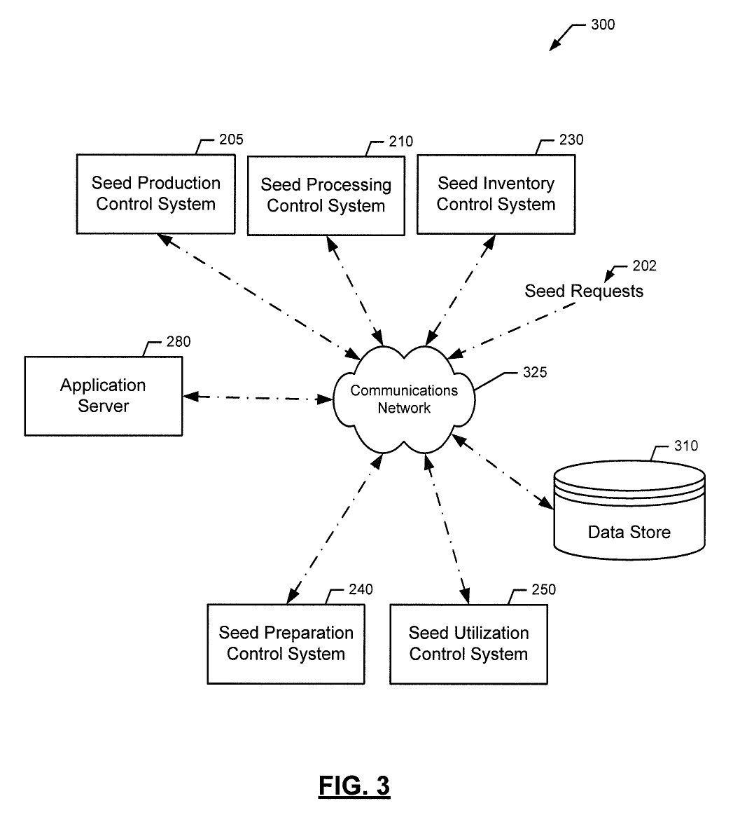

FIG. 3 shows a schematic representation of another exemplary seed coordinating system 300 in accordance with various embodiments of the present invention. As shown in the figure, seed coordinating system 300 includes seed production control system 205, seed processing control system 210, seed inventory control system 230, seed preparation control system 240, seed utilization control system 250, and application server 280. Data store 310, which in various embodiments may comprise, but need not be limited to, a local data store, a primary data store, a secondary data store, a single data store, multiple data stores, or any combinations thereof, is also shown as part of the seed coordinating system 300. In the depicted embodiment, the entities of seed coordinating system 300 operate in a similar manner as discussed above and communicate via a communications network 325. In this regard, communications network 325 can be, but is not limited to, a local area network (LAN), a wide area network (WAN), the Internet or some combination of networking technologies. As shown in the figure, seed requests 202 are depicted as being input directly to the communications network 325 for illustration purposes as representing one exemplary embodiment. However, according to various exemplary embodiments of the present invention, seed requests 202 may be input into the coordinating system 300 from any one or any combination of network entities.

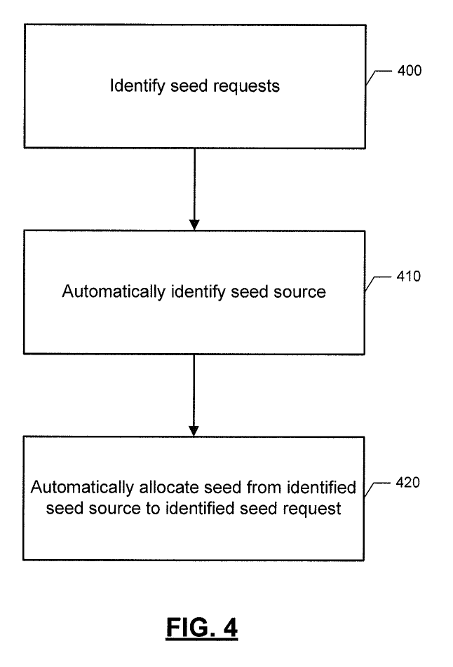

FIG. 4 is a flowchart of an exemplary method of the present invention for fulfilling seed requests. At 400, a seed request can be identified. According to various embodiments, a seed request can be identified by an application server, such as application server 280. As noted above, although in the depicted embodiment the application server identifies a seed request, in other embodiments other entities of the seed coordinating system may make this identification. Such entities may include, but need not be limited to, one or more data stores, such as primary data store 201, secondary data stores 220, 260, other data store 270, or any combinations thereof. In some exemplary embodiments, prior to identification of a seed request, the seed request may have been derived from one or more experiment plans. In some embodiments, the seed requests may be stored in a primary data store. In some embodiments, the seed request can be derived from an experiment plan. The identified seed request can include seed type criteria indicating the characteristics of the type of seed being requested.

At 410, at least one available seed source can be automatically identified. In this regard, according to various embodiments, an application server, such as application server 280, can query data associated with various management and inventory systems to locate a source for the requested seed. As noted above, although in the depicted embodiment an application server identifies the at least one available source, in other embodiments other entities of the seed coordinating system may make this identification. Such entities may include, but need not be limited to one or more data stores, such as primary data store 201, secondary data stores 220, 260, other data store 270, or any combinations thereof. According to some embodiments, the query can be defined based on a heuristic approach which can consider one or more seed requests concurrently against the supply of seed to maximize or otherwise coordinate the matching to seed requests. In some embodiments, the at least one available seed source may be identified from at least one of current management systems or current seed inventory. Further, in some embodiments, the current management systems may comprise seeds to be produced, seeds to be processed, seeds to be prepared, seeds to be utilized, and combinations thereof.

If a source of seed is identified, the seed at the identified source can be automatically allocated to the identified seed request at 420. In this regard, upon locating a match for the requested seed an order for the seed can be automatically generated allocating the seed to the identified request and providing instructions to take action with regard to the seed. In some embodiments, the seed may be allocated based upon preferences associated with an experiment plan.

It should be noted that for purposes of the current specification and appended drawings and claims, the terms automatic, automatically, and other forms thereof refer to operations that require minimal, or no, manual intervention. Thus, for example, whereas in some embodiments the system and methods provided herein may allocate seed sources for each seed request without manual intervention, in other embodiments some minimal manual intervention may be involved. For example, in some embodiments prior to allocating a least one seed source to at least one seed request, a user may initiate a query, report, or utility that identifies those seed requests that do not have allocated seed sources.

As described above and as will be appreciated by one skilled in the art, embodiments of the present invention may be configured as a system and method. Accordingly, embodiments of the present invention may be comprised of various means including entirely of hardware, entirely of software, or any combination of software and hardware. Furthermore, embodiments of the present invention may take the form of a computer program product consisting of a computer-readable storage medium and computer-readable program instructions (e.g., computer software) stored in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, systems, and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
identifying at least one seed request, said seed request containing at least one desired characteristic;
automatically identifying at least one available seed source having the desired characteristic; and
automatically allocating via a processor the at least one identified seed source to the at least one seed request.

2. The method of claim 1, wherein said processor is a processor of an application server.

3. The method of claim 1, wherein the at least one seed request is derived from one or more experiment plans stored in one or more data stores.

4. The method of claim 1, wherein seeds are allocated according to one or more preferences associated with a seed request.

5. The method of claim 1, wherein the at least one available seed source is identified from at least one of current management systems or current seed inventory.

6. The method of claim 5, wherein the current management systems comprise seeds selected from the group consisting of: seeds to be produced, seeds to be processed, seeds to be prepared, seeds to be utilized, and combinations thereof.

7. The method of claim 6, wherein at least a portion of the seeds to be produced comprises seeds to be processed by a seed processing system.

8. The method of claim 6, wherein at least a portion of the seeds to be utilized comprises seeds to be produced by a seed production system.

9. The method of claim 6, wherein at least a portion of the seeds to be processed comprises seeds to be prepared by a seed sample preparation system.

10. The method of claim 6, wherein at least a portion of the seeds to be prepared comprises seeds to be utilized by a seed utilization system.

11. The method of claim 5, wherein the current seed inventory comprises at least a portion of seeds selected from the group consisting of: seeds processed by a seed processing system, seeds prepared by a seed sample preparation system, seeds from other seed sources, and combinations thereof.

12. The method of claim 7, wherein the seeds to be processed by the seed processing system are identified in a data store that communicates with the seed processing system.

13. The method of claim 8, wherein the seeds to be produced by the seed production system are identified in a data store that communicates with the seed production system.

14. The method of claim 9, wherein the seeds to be prepared by the seed sample preparation system are identified in a data store that communicates with the seed sample preparation system.

15. The method of claim 10, wherein the seeds to be planted by the seed utilization system are identified in a data store that communicates with the seed utilization system.

16. The method of claim 11, wherein at least a portion of the seeds of the current seed inventory are identified in a data store that communicates with the current seed inventory.

17. The method of claim 1, wherein the desired characteristics are identified using seed inventory identifiers.

18. The method of claim 5, wherein said steps of identifying at least one seed request containing at least one desired characteristic, automatically identifying at least one available seed source having the desired characteristic, and automatically allocating the at least one identified seed source to the at least one seed request occur via an application server.

19. The method of claim 18, wherein the application server communicates with at least one data store, wherein at least one of the application server and the data store communicates with the current management systems, and wherein at least one of the application server and the data store communicates with the current seed inventory.

20. The method of claim 5, wherein automatically identifying at least one available seed source having the desired characteristic comprises querying the current seed inventory before querying the current management systems.

21. The method of claim 20, wherein automatically identifying at least one available seed source having the desired characteristic comprises querying a seed inventory system before querying a seed processing system.

22. The method of claim 21, wherein automatically identifying at least one available seed source having the desired characteristic further comprises querying a seed processing system before querying a seed preparation system.

23. The method of claim 22, wherein automatically identifying at least one available seed source having the desired characteristic further comprises querying a seed preparation system before querying a seed production system.

24. A coordinating system comprising:
a seed production system configured to produce at least a portion of seeds;
a seed processing system configured to process at least a portion of seeds from the seed production system;
a seed sample preparation system configured to prepare at least a portion of seeds from the seed processing system;
a seed utilization system configured to plant at least a portion of seeds from the seed sample preparation system;
a seed inventory configured to store seeds from at least one of seeds processed by the seed processing system, seeds prepared by the seed sample preparation system, and seeds from other seed sources; and
a data store in communication with the seed production system, the seed processing system, the seed sample preparation system, and the seed utilization system, the data store comprising at least one seed request, wherein the coordinating system is configured to automatically identify at least one available seed source from among seeds produced from the seed production system, seeds processed by the seed processing system, seeds prepared by the seed sample preparation system, seeds utilized by the seed utilization system, and seeds stored by the seed inventory, and wherein the coordinating system is further configured to automatically allocate the at least one identified seed source to the at least one seed request.

25. The coordinating system according to claim 24, further comprising an application server in communication with the data store, and wherein the application server is configured to automatically identify at least one available seed source and automatically allocate the at least one identified seed source to the at least one seed request.

26. The coordinating system according to claim 24, wherein the seed processing system is configured to process at least a portion of seeds from the seed production system.

27. The coordinating system according to claim 24, wherein at least one seed request is derived from one or more experiment plans stored in one or more data stores.

28. The coordinating system according to claim 24, further comprising a secondary data store configured to communicate with the seed processing system and the data store, and wherein the coordinating system automatically identifies at least one available seed source and allocates the at least one identified seed source to the at least one seed request through communication between the data store and the secondary data store.

29. The coordinating system according to claim 24, further comprising a secondary data store configured to communicate with the seed sample preparation system and the data store, and wherein the coordinating system automatically identifies at least one available seed source and allocates the at least one identified seed source to the at least one seed request through communication between the data store and the secondary data store.
